(19) United States
(12) Patent Application Publication
(10) Pub. No.: US 2026/0227238 A1
(43) Pub. Date: Aug. 6, 2026

(54) METHOD AND SYSTEM FOR OBTAINING REAL-TIME COLOR IMAGES USING DEFOCUS

(71) Applicants: Northwestern University, Evanston, IL (US); Purdue Research Foundation, West Lafayette, IN (US)

(72) Inventors: Qi Guo, West Lafayette, IN (US); Mehmet Kerem Aydin, Evanston, IL (US); Yi Chun Hung, Evanston, IL (US); Emma Bertat Alexander, Evanston, IL (US)

(21) Appl. No.: 19/529,763

(22) Filed: Feb. 4, 2026

Related U.S. Application Data
(60) Provisional application No. 63/754,304, filed on Feb. 5, 2025.

(51) Int. Cl. G01J 3/28; G01J 3/02; G06T 7/90

(52) U.S. Cl. CPC G01J 3/2823; G01J 3/0208; G06T 7/90; G01J 2003/284; G06T 2207/10016

(57) ABSTRACT

A system for obtaining color images includes a grayscale imaging device, a first lens positioned at a first distance from the grayscale imaging device, and a second lens positioned at a second distance from the grayscale imaging device, where the second distance is greater than the first distance. The system also includes a processor operatively coupled to the grayscale imaging device and configured to receive image data from the grayscale imaging device. The processor uses a compressed sensing framework to process the image data and the processor generates a hyperspectral image based on the processed image data.

### CROSS-REFERENCE TO RELATED APPLICATION

The present application claims the priority benefit of U.S. Provisional Patent App. No. 63/754,304 filed on Feb. 5, 2025, the entire disclosure of which is incorporated by reference herein.

### BACKGROUND

Hyperspectral imaging (HSI) has advanced significantly in recent years, providing imaging capabilities beyond the limitations of human color vision. By capturing detailed spectral information at each spatial point, HSI can support diverse applications in scientific research and computer vision. Conventional HSI systems often utilize a scanning process, capturing one two-dimensional (2D) slice along either spatial or spectral dimensions at a time. Scanning along the spectral dimension can be achieved by using either spectral band-pass filters or a tunable filter. Push-broom scanning, on the other hand, captures hyperspectral images line by line along the spatial dimension using a narrow slit, then spreads the spectral information across a 2D sensor with a dispersive prism.

### SUMMARY

An illustrative system for obtaining color images includes a grayscale imaging device, a first lens positioned at a first distance from the grayscale imaging device, and a second lens positioned at a second distance from the grayscale imaging device, where the second distance is greater than the first distance. The system also includes a processor operatively coupled to the grayscale imaging device and configured to receive image data from the grayscale imaging device. The processor uses a compressed sensing framework to process the image data and the processor generates a hyperspectral image based on the processed image data.

In one embodiment, the first lens is fixed in place and the second lens moves relative to the first lens. In another embodiment, the second lens moves between N positions corresponding to N different effective focal lengths. In another embodiment, the image data comprises unfocused grayscale image data. In another embodiment, the system includes an aperture on the second lens. In another embodiment, the second lens has a proximate surface and a distal surface, the distal surface is further from the grayscale imaging device than the proximate surface, and the aperture is mounted to the distal surface of the second lens. In another embodiment, the aperture has a shape of an octopus eye.

In one embodiment, the image data comprises a focal stack of grayscale images. In another embodiment, the processor processes the image data by solving an inverse problem that includes a linear two-dimensional convolutional matrix generated by a point spread function. In one embodiment, the processor formulates a minimization problem in eigenspace to solve the inverse problem. In another embodiment, the system includes a denoiser to suppress noise in the image data.

An illustrative method of obtaining color images includes capturing image data by a grayscale imaging device of an optical system. The optical system includes a first lens positioned at a first distance from the grayscale imaging device and a second lens positioned at a second distance from the grayscale imaging device, where the second distance is greater than the first distance. The method also includes processing, by a processor operatively coupled to the grayscale imaging device, the image data using a compressed sensing framework. The method further includes generating, by the processor, a hyperspectral image based on the processed image data.

In one embodiment, the first lens is fixed in place and the second lens moves relative to the first lens. In another embodiment, capturing the image data includes moving the second lens between N positions corresponding to N different effective focal lengths. In another embodiment, the image data comprises unfocused grayscale image data. In another embodiment, the method includes placing an aperture on the second lens. In an illustrative embodiment, the aperture is placed on a distal surface of the second lens. In another embodiment, the aperture has a shape of an octopus eye. In one embodiment, processing the image data includes solving an inverse problem that includes a linear two-dimensional convolutional matrix generated by a point spread function.

Other principal features and advantages of the invention will become apparent to those skilled in the art upon review of the following drawings, the detailed description, and the appended claims.

### BRIEF DESCRIPTION OF THE DRAWINGS

Illustrative embodiments of the invention will hereafter be described with reference to the accompanying drawings, wherein like numerals denote like elements.

FIG. 1A shows optics of the proposed system (upper) and the optics of an octopus eye (lower) in accordance with an illustrative embodiment.

FIG. 1B shows results of the proposed imaging system capturing a grayscale focal stack to reconstruct images in real time in accordance with an illustrative embodiment.

FIG. 2A depicts an optical system that includes a lens pair in which the second lens moves along the N positions, corresponding to the effective focal lengths {f1, f2, . . . fN}, to capture a focal stack with a grayscale sensor in accordance with an illustrative embodiment.

FIG. 2B depicts PSFs for each wavelength band for 6 of the 12 lens positions in accordance with an illustrative embodiment.

FIG. 2C depicts an optical system with a lens pair in which the second lens is translated to five discrete positions, z₁, z₂, . . . , z₅ in accordance with an illustrative embodiment.

FIG. 2D depicts measured point spread functions (PSFs) from the real-world prototype at different wavelengths λᵢ and lens positions zᵢ, showing how the focal plane shifts in accordance with an illustrative embodiment.

FIG. 3A depicts a first comparison of imaging using ground truth, SDC, Choi et al., MST, KRISM, and the proposed CfD in accordance with an illustrative embodiment.

FIG. 3B depicts a second comparison of imaging using ground truth, SDC, Choi et al., MST, KRISM, and the proposed CfD in accordance with an illustrative embodiment.

FIG. 3C depicts a third comparison of imaging using ground truth, SDC, Choi et al., MST, KRISM, and the proposed CfD in accordance with an illustrative embodiment.

FIG. 3D depicts a fourth comparison of imaging using ground truth, SDC, Choi et al., MST, KRISM, and the proposed CfD in accordance with an illustrative embodiment.

FIG. 3E is a table that summarizes the spectral imaging modalities of FIGS. 3A-3D in terms of performance, computational cost, and optical complexity in accordance with an illustrative embodiment.

FIG. 4 shows the effect of the channel count C on SAM for the method, averaged over reconstructions of 10 ICVL images, each containing 245 bands in the visible range in accordance with an illustrative embodiment.

FIG. 5A depicts a reconstructed image and three example spectral curves in accordance with an illustrative embodiment.

FIG. 5B shows, for each square in the color chart, the ground truth (left) and reconstructed (right) luminance normalized BT.709 RGB renders in accordance with an illustrative embodiment.

FIG. 6 shows several scenes assembled in the lab, illustrating spatial and spectral effects in the reconstructions in accordance with an illustrative embodiment.

FIG. 7 depicts the spectral characteristics of the critical components used in the system in accordance with an illustrative embodiment.

FIG. 8 depicts chromatic focal shift of the lens pair used in the proposed system in accordance with an illustrative embodiment.

FIG. 9 is table that depicts ADMM parameters for simulation and real data in accordance with an illustrative embodiment.

FIG. 10 depicts the results of the reconstruction from misaligned images, compared to the aligned reconstruction in accordance with an illustrative embodiment.

FIG. 11 shows that spatial reconstruction quality improves with an increasing number of measurements but saturates beyond eight measurements, in accordance with an illustrative embodiment.

FIG. 12A shows the vertical components and horizontal components in accordance with an illustrative embodiment.

FIG. 12B is a histogram depicting the overall distribution of values in accordance with an illustrative embodiment.

FIG. 13 depicts RGB scene images composed using measurements without white balance in accordance with an illustrative embodiment.

FIG. 14 shows RGB scene images composed using measurements with white balance in accordance with an illustrative embodiment.

FIG. 15 considers the effect of prior information on reconstruction results and compares use of a deep denoiser to use of l1-norm regularization in accordance with an illustrative embodiment.

FIG. 16 depicts a computing device that generates images for a color from defocus imaging system in accordance with an illustrative embodiment.

### DETAILED DESCRIPTION

Classic color imaging trades off spatial resolution for spectral channels using pixel filter arrays, and hyper-spectral imaging faces even tighter trade-offs in spatial/spectral/temporal resolution. Compressed sensing can break through these trade-offs, but adds optical and/or computational complexity. To overcome these limitations, the inventors propose a bio-inspired Color from Defocus (CfD) camera. The system leverages chromatic aberration in defocused grayscale images to reconstruct RGB and hyperspectral images. In one embodiment, the proposed camera is constructed using two low-cost, off-the-shelf lenses in combination with a CMOS sensor. Additionally, the computationally-efficient CfD algorithm enables real-time image reconstruction (<1 s/frame). With these advantages, the proposed method pushes the boundaries of color imaging in resource-constrained settings.

Color imaging is a specialized form of spectral imaging that captures only three spectral channels, closely aligned with human color vision. Unlike hyperspectral imaging, color imaging is widely accessible and commonly found in low-cost consumer devices. While color imaging captures significantly fewer spectral channels than hyperspectral imaging, this reduction in channels has enabled the development of a range of technologies not typically seen in hyperspectral systems. The most prevalent color imaging technology today is the use of spectral filter arrays placed on top of imaging sensors, with each pixel capturing a different spectral band. This method is both cost-effective and versatile. However, this method has two major drawbacks: reduced spatial resolution and decreased light throughput due to the filtering of incoming light.

Compressive sensing (CS) is a class of techniques that reconstructs a signal using fewer measurements than the dimensionality of the original data. This is accomplished by exploiting low-rank models of the original signal. Several methods have been proposed to model hyper-spectral images using low-rank representations. A popular low-rank representation, which is used herein, is truncation of principle components. CS reconstruction typically requires solving an ill-posed inverse problem, where the signal is recovered from coded measurements. By employing lower-dimensional models, one can mitigate the ill-posedness of the inverse problem, improving the reconstruction process. Approaches to reconstruction are discussed below, along with an optimization based algorithm.

Camera Defocus occurs when light from a small point in the scene fails to converge to a single point on the image sensor, resulting in a blurred image. Defocus can arise from several factors, including depth variations, spherical aberration, and chromatic aberration. Longitudinal chromatic aberration, which is the most relevant source of defocus for the proposed system, arises when different wavelengths of light focus at different distances from a lens due to dispersion.

Inspired by cephalopods (e.g. octopus, squid, cuttlefish), which have been hypothesized to use chromatic aberration to perceive colors with a single photoreceptor type, the inventors posed the question: Can one reconstruct a hyperspectral image using chromatic aberration with simple optics and lightweight computation? In answer to this question, the proposed CfD system reconstructs hyperspectral images from focal stacks of grayscale images, collected using low-cost, off-the-shelf optics and processed for less than a second with a compressed sensing framework for chromatic aberration.

Compressed sensing has become a crucial technique in the field of hyperspectral imaging (HSI) to manage the large data volumes characteristic of hyperspectral datasets. To implement an effective CS-based hyperspectral imaging system, both hardware and algorithm are essential, acting as multiplicative factors in system performance. Therefore, discussed separately below are the hardware and the algorithm of the proposed system. Also provided below is an overview of various coded aperture snapshot spectral imaging (CASSI) techniques, alongside KRISM and DiffuserCam. The application also discusses optimization-based and data-driven approaches for solving inverse problems in hyperspectral CS imaging.

Regarding hardware, CASSI has gained popularity for its ability to significantly reduce the number of measurements required in hyperspectral imaging. CASSI systems combine coded apertures with dispersers to modulate spectral information. By solving an inverse problem associated with the spatial-spectral multiplexing, CASSI can reconstruct the hyperspectral image. Dual disperser CASSI (DD-CASSI) uses two prisms as dispersers and the coded apertures based on an order-15 cyclic S-matrix. To simplify the optics, single disperser CASSI (SD-CASSI) uses a single prism and a coded aperture based on an order 192 S-matrix code. This design, additionally, provides simultaneous multiplexing along both spatial and spectral dimensions, potentially preserving more information. Extending SD-CASSI, colored CASSI (C-CASSI) further replaces the binary coded aperture with a colored coded aperture, which can then be optimized for the Restricted Isometry Property in CS problems. In contrast, spatial-spectral compressive spectral imaging (SSCSI) adopts a diffraction grating and a coded attenuation mask to achieve simultaneous spatial-spectral multiplexing. Of the CASSI systems, the inventors used a SS-CASSI system by Choi et al. to a DD-CASSI system by Cai et al. (dubbed MST) as a basis of comparison.

Super-pixelated adaptive spatio-spectral imaging (SASSI) selectively samples spectral data from specific spatial points, which are determined by the locations of superpixels in a captured grayscale image. By fusing this spectral information with the grayscale image, SASSI reconstructs a complete hyperspectral image. DiffuserCam aims to design a more compact imager, utilizing a tiled spectral filter and a diffuser for multiplexing spatial-spectral information. However, this design comes at the cost of larger point spread functions (PSFs), potentially jeopardizing the spatial resolution of the reconstructed hyperspectral image. Unlike the above works, which rely on solving inverse problems for reconstruction hyperspectral images, KRISM employs an optical implementation of the Krylov subspace method, allowing it to directly measure the singular vectors and values of the hyperspectral image to recover the hyperspectral image.

Algorithms and methods developed for solving inverse problems in HSI can be broadly categorized into two approaches: optimization-based and data-driven. In optimization-based approaches, an iterative shrinkage-thresholding algorithm (ISTA), a fast iterative shrinking-thresholding algorithm (FISTA), and time-resolved angiography with interleaved stochastic trajectories (TwIST) are commonly associated with the l₁-norm regularizer. Additionally, alternating direction method of multipliers (ADMM) and Primal-Dual Hybrid Gradient (PDHG) solve the inverse problem by alternately updating primal and dual variables, and they are often employed with a wider variety of regularizers. The above approaches not only demonstrate effective performance in solving inverse problems but also offer provable convergence rates under certain mild conditions.

In data-driven approaches, convolutional neural networks (CNNs) are the common backbone for processing the spatial information. Since hyperspectral images typically exhibit high correlation across spectral channels, many studies have focused on designing parameterized modules to effectively capture this correlation. For example, MST proposed Spectral-wise Multihead Self-Attention (S-MSA) to capture spectral-wise similarity in HSI reconstruction. In other works, a two-stage framework is utilized, where the first CNN-based stage extracts coarse features, and the second attention-based stage refines the reconstruction.

Hybrid methods have also been proposed to leverage the respective advantages of both categories. PnP-ADMM replaces the denoising step in the primal update of ADMM with an off-the-shelf learning-based denoiser. Unrolled algorithms unroll iterative optimization algorithms into several consecutive stages, each including learned parameterized models. Due to the nature of unrolling, the performance and computational complexity are closely linked to the pre-fixed number of iterations.

The proposed methods and systems are able to reconstruct a hyperspectral image X∈R^{H·W×C} of a target scene using grayscale images Y∈R^{H·W×N}, where H, W, and C represent the height, width and channel count of the image, respectively. The number of captured grayscale images used for reconstruction is denoted as N. Since each grayscale image Yᵢ, where i=1, . . . , N, is captured under an effective focal length fᵢ of a lens pair (details provided below), one can express the forward model between X and Y as follows:

$$y = {CH}_{x} = C ( \begin{matrix}{H}_{1 , 1} & … & {H}_{1 , C} \\ ⋮ & ⋱ & ⋮ \\ {H}_{N , 1} & … & {H}_{N , C}\end{matrix} ) x , \qquad Eq . 1$$

where each block H_{i,j}∈R^{(H+K-1)·(W+K-1)×H·W} is a linear 2D convolutional matrix generated by a point spread function (PSF) K (fᵢ, λᵢ), corresponds to an effective focal length fᵢ of the lens pair at wavelength λᵢ, associated with the j^{th} channel of X. The binary matrix C∈R^{N·H·W×N·(H+K-1)·(W+K-1)} is used to crop the targeted region of the convolved result (i.e., Hx), ensuring that the pixel count between x and y remains the same. Here, one can vectorize the images X and Y using column-stacking, defining x=vec(X):=[X^{T}, . . . , X^{T}]^{T} and y=vec(Y), where Xᵢ denotes the i column of the matrix X. Here, Xᵢ can also be interpreted as the i^{th} channel of the hyperspectral image.

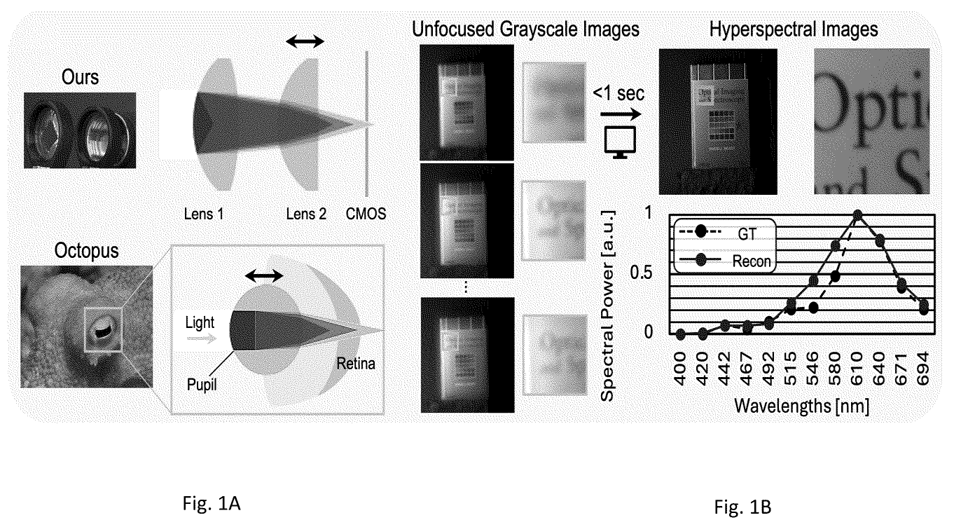

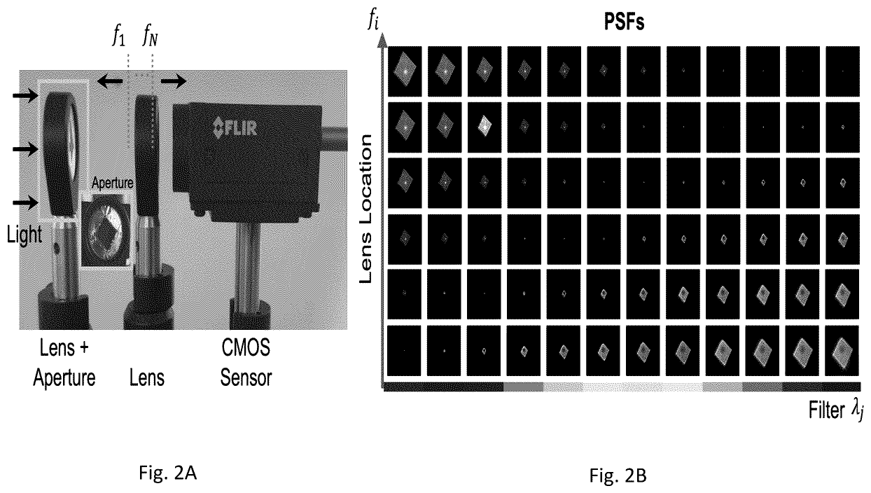

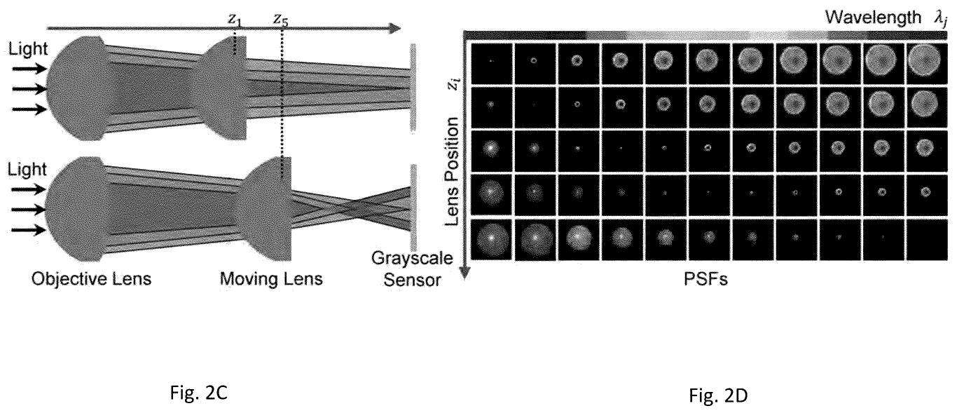

An illustrative optical system is described below. The proof-of-concept optical imaging system includes a visible-wavelength filter (e.g., Thorlab FESH0700), an aperture (see FIG. 2A), a pair of lenses with 50 mm focal lengths (e.g., Thorlab LBF254-050-A and AL2550M-A), and a grayscale camera (e.g., FLIR GS3-U3-23S6M). In alternative embodiments, the system can include different types of components. FIG. 1A shows optics of the proposed system (upper) and the optics of an octopus eye (lower) in accordance with an illustrative embodiment. As discussed, the camera uses a moving lens to change the focus of chromatically aberrated light on its way to a grayscale sensor. This simple optical system is made of inexpensive, off-the-shelf components, and is inspired by the eye of the octopus.

The aperture shape, inspired by the octopus eye, reduces the sizes of the PSFs for improved reconstruction stability. In this configuration, the camera's field of view is determined by the lens farther away from the camera (i.e., distal lens), and the effective focal length fᵢ of a lens pair can be adjusted by translating the position of the lens closer to the camera along the direction of light propagation. The aperture shape is positioned closely over the distal surface of the distal lens (further away from the camera). To characterize the PSFs K(fᵢ, λⱼ) at different effective focal lengths and target wavelengths, the inventors imaged a point source through 12 visible bandpass filters with central wavelengths located from 400-694 nm (see FIG. 1B), defined as the set {λⱼ}_{j=1 . . . , 12}. Additionally, based on the lens characteristics, the inventors selected 12 effective focal lengths {fᵢ}_{i=1 . . . , 12}, corresponding to 12 discrete translation positions of the lens closer to the grayscale camera. By measuring the PSFs for each combination of fᵢ and λⱼ, the inventors characterized K(fᵢ, λⱼ) as shown in FIG. 2B. It is noted that depth variation in PSFs was ignored, and scenes were imaged at a fixed distance (~3 m) from the camera.

FIG. 1B shows results of the proposed imaging system capturing a grayscale focal stack to reconstruct images in real time in accordance with an illustrative embodiment. More specifically, FIG. 1B shows an RGB projection of a 12-channel recovered image, with a high-resolution inset (square) and reconstructed spectrum (star).

FIG. 2 shows a hardware prototype and calibration PSFs. FIG. 2A depicts an optical system that includes a lens pair in which the second lens moves along the N positions, corresponding to the effective focal lengths {f1, f2, . . . fN}, to capture a focal stack with a grayscale sensor in accordance with an illustrative embodiment. The calibration procedure uses 12 filters with central wavelengths {λ1, |2, . . . λC}, where C=12. Since C=12, one can also set N=12. To reconstruct scenes, the inventors measure flexibly from subsets of these positions. FIG. 2B depicts PSFs for each wavelength band for 6 of the 12 lens positions in accordance with an illustrative embodiment. In each lens location, shorter wavelengths experience more dramatic changes from filter to filter than longer ones. This wavelength dependence of the chromatic focal shift gives the proposed method higher accuracy in violet than red for recovered spectra.

FIG. 2C depicts an optical system with a lens pair in which the second lens is translated to five discrete positions, z₁, z₂, . . . , z₅ in accordance with an illustrative embodiment. At each position zᵢ, the captured image Iᵢ is focused on a corresponding wavelength λᵢ, while other wavelengths appear blurred. Together, these measurements form a chromatic focal stack. FIG. 2D depicts measured point spread functions (PSFs) from the real-world prototype at different wavelengths λᵢ and lens positions zᵢ, showing how the focal plane shifts in accordance with an illustrative embodiment. While calibration PSFs are collected with the help of a narrow-band tunable filter, at deployment time the grayscale sensor measures only the scene-weighted sum of incoming light across all wavelengths at each of the five lens positions.

To solve the inverse problem of Eq. 1, a minimization problem was formulated in an eigenspace as follows:

$${min}_{z} \frac{1}{2} ‖ y - CHPz ‖ + {Φ}_{θ} ( Pz ) , \qquad Eq . 2$$

where Φ_{θ}(·) is an off-the-shelf deep-learning-based regularizer with parameters θ. The vector Z∈R^{H·W·v}, where v represents the dimensionality of the selected eigenspace, is utilized to exploit the property that natural visible-range spectra primarily reside in a lower-dimensional space (i.e., x≈Pz). One can define P=⊗I_{HW}, where the rows of B, shaped as R^{v×C}, are eigenvectors obtained from the Harvard dataset. The matrix I_{HW} and the operator ⊗ denote an identity matrix shaped as R^{HW×HW} and the Kronecker product, respectively. To adopt a plug-and-play ADMM, the inventors transformed Eq. 2 by introducing slack variables v and u, and by using the change of variables Ĥ:=HP:

$${min}_{z , u , v} \frac{1}{2} {‖ y - Cv ‖}_{2}^{2} + {Φ}_{θ} ( u ) \qquad Eq . 3$$

$$s . t . v = \hat{H} z , u = z .$$

Followed by the derivation of ADMM, one can obtain Algorithm 1 (below) for solving Eq. 3. Here, ξ and η denote dual variables.

ALGORITHM 1
Plμg-and-play ADMM Iterative Procedμre

| | |
|---|---|
| 1: | Given: μ₁, μ₂ > 0, and φθ(·) as an off-the-shelf deep |
| | learning denoiser. |
| 2: | while not converged do |
| 3. | υᵢ₊₁ ← (C^{T}C + μ₁I)⁻¹(C^{T}y + μ₁Ĥzᵢ − ξᵢ) |
| 4. | zᵢ₊₁ ← (μ₁Ĥ^{T} Ĥ + μ₂I)⁻¹ (Ĥ^{T} (μ₁υᵢ + ξᵢ) + (ηᵢ + μ₂μ₁)) |
| 5. | uᵢ₊₁ ← P^{T}Ø_{θ}P(zᵢ₊₁ + ηᵢ) |
| 6. | ξᵢ₊₁ ← ξᵢ + μ₁(υᵢ₊₁ − Ĥzᵢ₊₁) |
| 7. | ηᵢ₊₁ ← ηᵢ + μ₂(uᵢ₊₁ − zᵢ₊₁ |
| 8. | end while |

Plug-and-play ADMM primarily includes two main update operations: a primal variable update (v, z, u) and a dual variable update (ξ and η). In the primal update, v can be interpreted as a pseudo-measurement estimated from the true measurement y and the current update zᵢ. An estimate of a projected image zᵢ₊₁ is then generated using a Wiener-like filter, (μ₁H\hat{ }T H\hat{ }+μ₂I)⁻¹. Since this estimate may contain noise, the proposed algorithm further applies an off-the-shelf deep learning denoiser φ_{θ}(·) to suppress noise and enhance the result. The inventors applied the denoiser after converting zᵢ₊₁ back to the image domain, as the off-the-shelf denoiser was trained on data in the hyperspectral image domain. In the dual update, ξ and η are updated by evaluating the residual of the constraints in Eq. 3. By iteratively alternating between primal and dual updates, the algorithm can heuristically converge to produce a projected image, which can then be used to recover a hyper-spectral image (i.e., x≈Pz). It should be noted that the update of z involves the inversion of a large non-diagonal matrix. To address this issue, the inventors implemented the update in the Fourier space by leveraging the Block Circulant with Circulant Blocks (BCCB) matrix structure of H (discussed below). As a final operation, corrections were made for the spectral response curve of the grayscale camera and visible light filter.

The inventors evaluated the performance of the CfD camera on three publicly available hyperspectral image datasets and compared to several state-of-the-art methods. Photon noise was simulated for all methods using a Poisson process. Specifically, it was assumed the camera captures 9.6×10⁷ photons per second in the visible range over an exposure time of 3 seconds, which corresponds to the typical brightness level of an indoor setting. If multiple exposures were required by the reconstruction algorithm, the time budget was divided across the measurements. For simplicity, it was assumed that optical components, such as aperture codes and spectral filters, did not block any incoming light. Additionally, the inventors assumed an ideal camera with negligible transition time between measurements, infinite dynamic range, no quantization error, and zero readout noise.

Snapshot techniques, such as Choi et al.'s CASSI and Spectral Diffuser Cam (SDC), reconstruct hyperspectral images from a single long-exposure grayscale image. In contrast, while the proposed method utilizes at least two measurements to recover spectral information, the BCCB matrix's structure can deliver superior noise resistibility in the inverse problem. This noise-resistant inversion process allows one to tolerate worse shot noise, enabling one to distribute the photon budget across multiple measurements. As a result, one can achieve high-quality reconstructions without significant delays. In terms of efficiency, while reconstruction times for Choi et al. and SDC exceed 10 minutes, CfD completes the process in under 1 second. SDC also experiences a significant drop in spatial resolution.

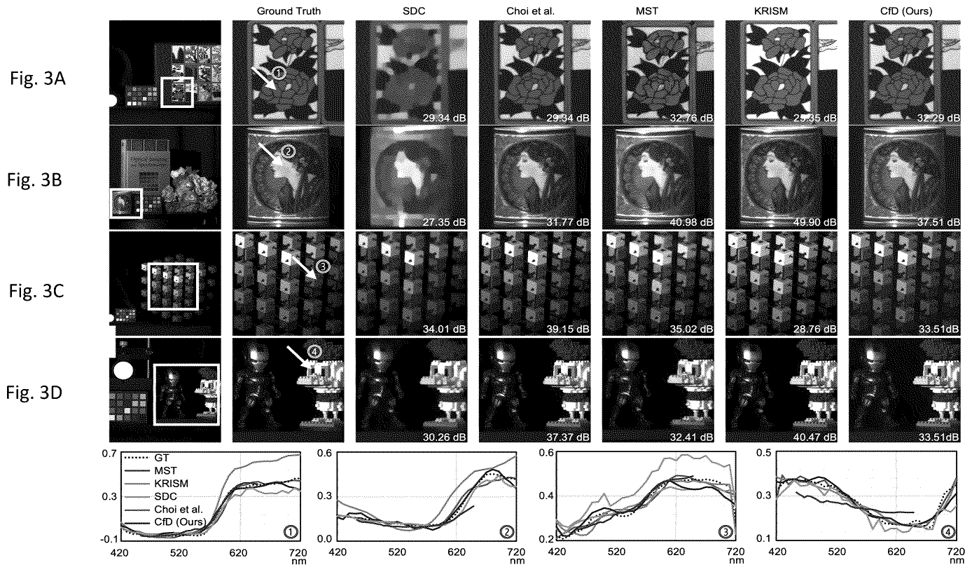

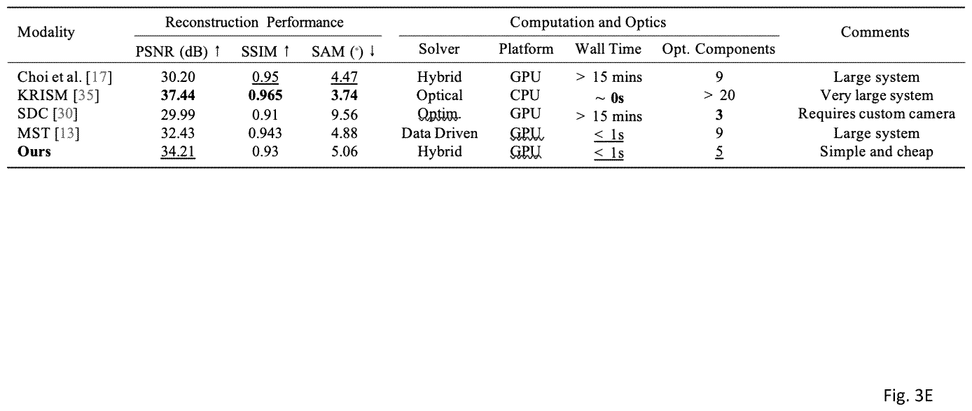

FIG. 3 shows the performance of several SOTA methods simulated on four hyperspectral images from the KAIST dataset. FIG. 3A depicts a first comparison of imaging using ground truth, SDC, Choi et al., MST, KRISM, and the proposed CfD in accordance with an illustrative embodiment. FIG. 3B depicts a second comparison of imaging using ground truth, SDC, Choi et al., MST, KRISM, and the proposed CfD in accordance with an illustrative embodiment. FIG. 3C depicts a third comparison of imaging using ground truth, SDC, Choi et al., MST, KRISM, and the proposed CfD in accordance with an illustrative embodiment. FIG. 3D depicts a fourth comparison of imaging using ground truth, SDC, Choi et al., MST, KRISM, and the proposed CfD in accordance with an illustrative embodiment. The PSNR of the reconstructed hyperspectral image is listed for each, below an RGB projection of the data. The method, using a simulated focal stack of 5 measurements, performs well, with high spatial resolution (compared to SDC) and no color tinting (compared to MST). Spectra are shown for the numbered points, indicated with white arrows on each image. The inventors reconstructed spectra smoothly and accurately. It is noted that MST can only reconstruct a limited wavelength range, as its training data spans only 453-648 nm.

As shown in FIG. 3, the MST method addresses the issue of long reconstruction times and improves reconstruction quality over Choi et al. and SDC. However, its data-driven approach is less flexible: the current network architecture and training are limited to reconstructing images within a 450-650 nm spectral band, in contrast to the 420-720 nm range used in the present work and across other methods. Unlike optimization-based approaches, MST cannot easily adjust its target spectral range without substantial changes to its architecture and retraining. This limitation results in the color tint observed in FIG. 3.

The inventors also compared the results with another multi-frame technique, KRISM. KRISM effectively has zero wall time for reconstruction, as it directly measures the singular vectors of the scene. However, it requires the most complex optical setup of all the methods discussed herein, making it impractical for applications that require portability. On average, KRISM outperforms CfD. Yet, as shown in FIG. 3A, its performance significantly degrades when the scene's reflectance cannot be effectively represented by the estimated singular vectors. This mismatch leads to poor results when the scene consists of a diverse set of spectral reflectivities. In contrast, CfD offers more consistent reconstruction performance across a wide range of scenes.

FIG. 3E is a table that summarizes the spectral imaging modalities of FIGS. 3A-3D in terms of performance, computational cost, and optical complexity in accordance with an illustrative embodiment. Reconstruction quality is benchmarked on 30 images from the Harvard dataset. Timings are reported for an NVIDIA RTX A6000. The count of optical components includes: lenses, apertures, prisms, actuators, SLMs, and sensors, but not control electronics. This comparison highlights the competitive image reconstruction (in PSNR ↑, SSIM ↑, and Spectral Angle Mapper SAM ↓), in combination with fast computing and a simple optical system.

The inventors built a prototype camera according to the description herein, illustrated in FIG. 2. The inventors imaged and reconstructed several real scenes, with data and code publicly available on a GitHub page. Objects were placed at a distance of 2.8 meters from the camera, at which depth the camera has a theoretical depth of field of 0.37 m for a 2-pixel circle of confusion (details below). It was ensured that all test targets remained within this depth of field to minimize the impact of depth on blur size.

In addition to keeping the targets within the depth of field, positioning them close to the optical axis helps mitigate focal length variations caused by spherical aberration and minimizes lateral chromatic aberration. These optical effects, which are not modeled in the CfD algorithm, remain a source of model mismatch. To minimize their impact on the reconstruction algorithm, the inventors center-crop the image around the test target, where the optical system performs closest to ideal.

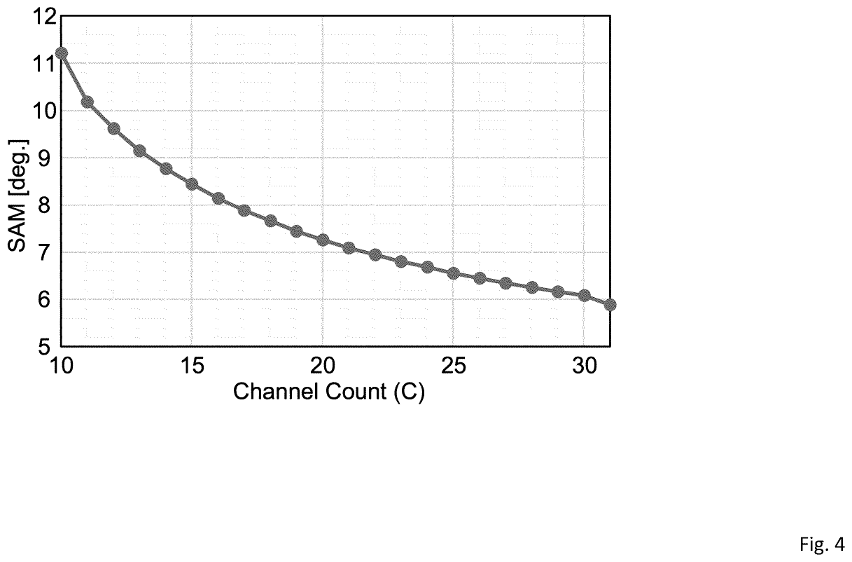

FIG. 4 shows the effect of the channel count C on SAM for the method, averaged over reconstructions of 10 ICVL images, each containing 245 bands in the visible range in accordance with an illustrative embodiment. FIG. 4 shows that calibrating with more PSFs improves performance and that a higher channel count C, requiring C calibrated PSFs, results in a lower spectral error. The figure also demonstrates that the system requires C≥25 within the 400-700 nm range to achieve the highest image quality. The gap between the spectral dimension of the underlying data and the targeted C slightly elevates the SAM, as observed by comparing the SAM values in FIG. 3E. This increase occurs because the high-dimensional image simulation more closely approximates continuous spectra, introducing potential model mismatch.

The current prototype is calibrated with a filter set of only 12 channels. This reduction in fidelity due to limited PSF sampling can be addressed in practice by collecting additional measurements at test time, or equivalently sampling over more lens positions, to improve the condition number of the Wiener-like filter described above. The inventors empirically selected sets of lens positions that lead to high quality image reconstructions. Results here are reported using lens position sets {f₁, f₃, f₄, f₅, f₆, f₇, f₁₀, f₁₁} (default) and {f₃, f₅, f₇, f₁₁} (results in visible artifacts).

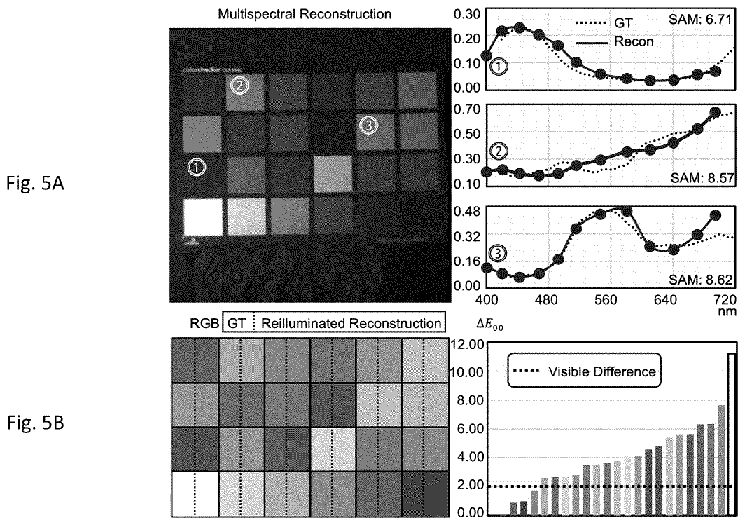

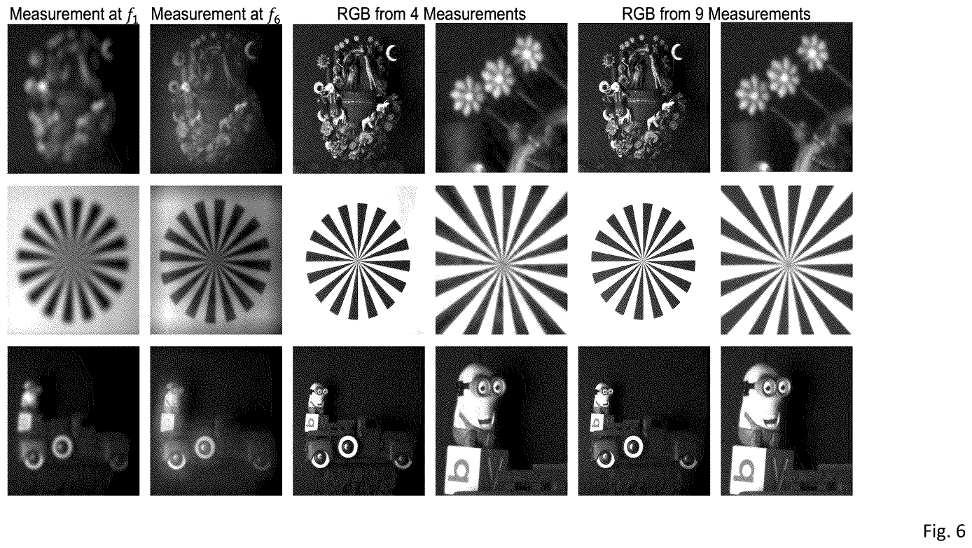

To assess the spectral accuracy and trichromatic color quality of the CfD algorithm, the inventors imaged the standard Macbeth color chart, shown in FIG. 5. More specifically, the inventors reconstructed the Macbeth color chart from a 9-measurement focal stack to evaluate hyperspectral and trichromatic reconstruction quality. For spectral accuracy evaluation, the inventors sampled a pixel from each color patch in the reconstruction. The inventors then used a Spectral Angle Mapper (SAM) to compare each sample's spectral accuracy to the known reflectance of the patch, adjusted by the scene's illuminance spectrum. The average SAM angle across patches was 9.3°, excluding the black patch for which this measurement has low stability. This result matches the predicted drop in accuracy due to the limited sampling of the PSFs, which was described in FIG. 4. FIG. 5A depicts a reconstructed image and three example spectral curves in accordance with an illustrative embodiment. SAM error is reported in degrees, with an average SAM overall squares of 9.3°. FIG. 5B shows, for each square in the color chart, the ground truth (left) and reconstructed (right) luminance normalized BT.709 RGB renders in accordance with an illustrative embodiment. The ΔE₀₀ perceptual error confirms that most trichromatic errors are visible (above dotted line) but small.

Additionally, the inventors characterized the accuracy of color reproduction with respect to human vision in terms of the perceptual color difference metric, ΔE₀₀, as follows. First, the inventors modeled the known Macbeth chart reflectances R(λ) under the test illuminant P (λ) resulting in a ground truth reference spectra S_{GT} (2)=R(λ)P (λ). The inventors then projected this ground truth spectra S_{GT} (λ) into the CIE XYZ color space by multiplying and integrating over the human color matching functions x̅, y̅, z̅:

$$X = α \int \overline{x} ( λ ) S ( λ ) d λ , \qquad Eq . 4$$

$$Y = α \int \overline{y} ( λ ) S ( λ ) d λ , \qquad Eq . 5$$

$$Z = α \int \overline{z} ( λ ) S ( λ ) d λ . \qquad Eq . 6$$

In Equations 4-6, α is a normalization factor. The inventors repeat this spectra- to XYZ-process with a reconstructed spectra S_{CfD}(λ). For the purposes of this application, where low luminance reflective surfaces are being evaluated, one can use the perceptual difference metric ΔE₀₀, which measures differences in the L*a*b* color space. One can also use the XYZ of the illuminant P (λ) as the adapting white point during conversion to L*a*b*. To reduce the effects of non-uniform illumination in the scene and to especially highlight spectral color quality difference, the luminance between the two colors was first normalized before evaluating the color difference:

$$XY {Z}_{CfD} = XY {Z}_{CfD} * {Y}_{GT} / {Y}_{CfD} , \qquad Eq . 7$$

$$Δ {E}_{00} = ( XY {Z}_{GT} , XY {Z}_{CfD} ; XY {Z}_{P} . \qquad Eq . 8$$

The ΔE₀₀ values for each of the 24 Macbeth color checker squares are shown in FIG. 5B. A ΔE₀₀ value at or below 2 is considered perceptually equivalent. The average ΔE₀₀ color difference across the entire Macbeth chart is 3.95. Although this is above the visual threshold, in a side-by-side viewing experience these differences are likely to go unnoticed.

To visualize this color difference between the ground truth spectra and the reconstructed spectra, the inventors render the visual differences of the Macbeth chart side by side in FIG. 5B. Each square is split in half. The left half is the ground truth, and the right half is the reconstruction, mapped to the ITU-R BT.709 color space. As indicated by ΔE₀₀ values, some differences are visible (above dashed line) but are quite small.

FIG. 6 shows several scenes assembled in the lab, illustrating spatial and spectral effects in the reconstructions in accordance with an illustrative embodiment. On the left is shown two example measurements, where f₆ is visually the most in focus image from the focal stack. From four measurements, the reconstructed RGB images show some spatial and spectral artifacts, such as the false color patterns within the black and white pinwheel target. Including additional measurements stabilizes the inversion and removes these false color patterns, while sharpening edges and boosting saturation. Further increasing the measurement count does not affect the RGB image but continues to contribute to spectra.

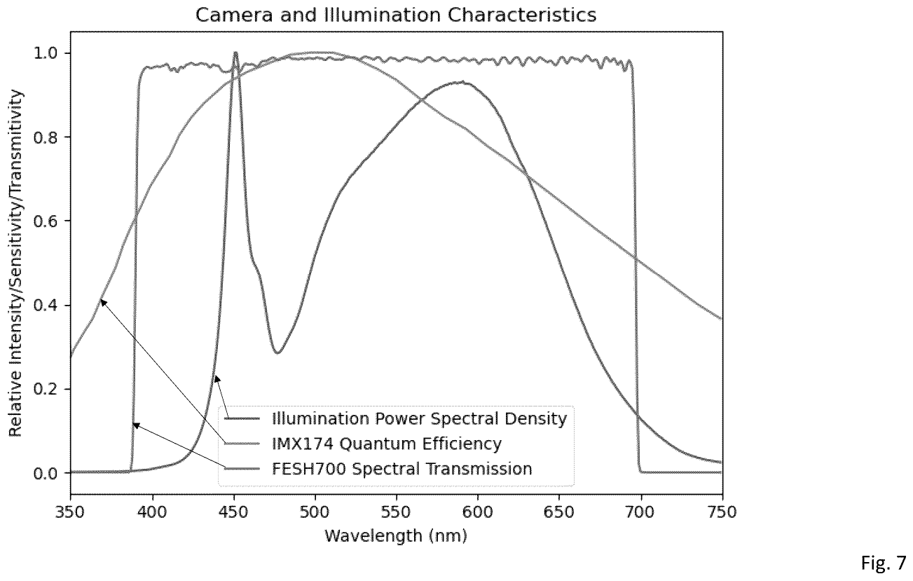

Included below are supplemental materials that provide additional information regarding the proposed methods and systems. FIG. 7 depicts the spectral characteristics of the critical components used in the system in accordance with an illustrative embodiment. The quantum efficiency of the camera and the transmittance of the filter were obtained from the manufacturer's specifications. The illumination power spectral density was measured in the lab. Throughout all experiments, the inventors accounted for the camera's quantum efficiency. However, scene illumination was only corrected during the quantitative evaluation of the method.

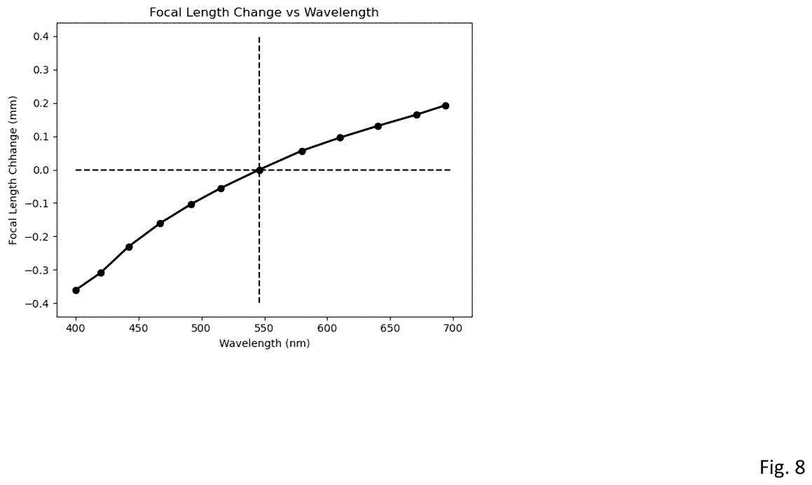

FIG. 8 depicts chromatic focal shift of the lens pair used in the proposed system in accordance with an illustrative embodiment. The focal length change is obtained by the combined focal length formula,

$$\frac{1}{f} = \frac{1}{{f}_{1}} + \frac{1}{{f}_{2}} - \frac{d}{{f}_{1} {f}_{2}} ,$$

where f, f₁, f₂, and d are an effective focal length, focal lengths of the lens pair in the optical system, and the distance between the two lenses, respectively.

The inventors also performed depth of field analysis for the proposed system. With CfD, the PSF size is used as a cue to recover the spectrum. However, the proposed algorithm does not account for PSF size changes caused by depth variations in the scene. The theoretical depth of field (DoF) of the proposed optical system (s>>f) is given by:

$$DoF = \frac{2 {NCs}^{2}}{{f}^{2}} , \qquad Eq . 9$$

where N is the aperture number, C is the circle of confusion, s is the distance between the camera and the subject, and f is the effective focal length of the system. At a depth of 2.8 m and a circle of confusion size of approximately 2 pixels (11.76 μm), the proposed system has a DoF of 0.37 m. In simulations, it is assumed the scene is flat and has a depth of 2.8 m. For real experiments, the inventors ensured that all test targets were positioned within this region to minimize the effects of depth variations of PSF size.

The performance of the ADMM method is highly sensitive to its parameters, μ₁ and μ₂, which control the balance between data fidelity and regularization. These parameters are carefully tuned to achieve optimal reconstruction quality. Improper selection of μ₁ and μ₂ can lead to suboptimal convergence, increased numerical errors, or over-smoothing of the reconstructed image. A new set of hyperparameters should be picked when parameters such as image size, FFT size and PSF are changed. While factors like the number of measurements and inner dimensionality also influence reconstruction, the proposed algorithm demonstrates greater robustness to changes in these parameters, requiring less frequent retuning.

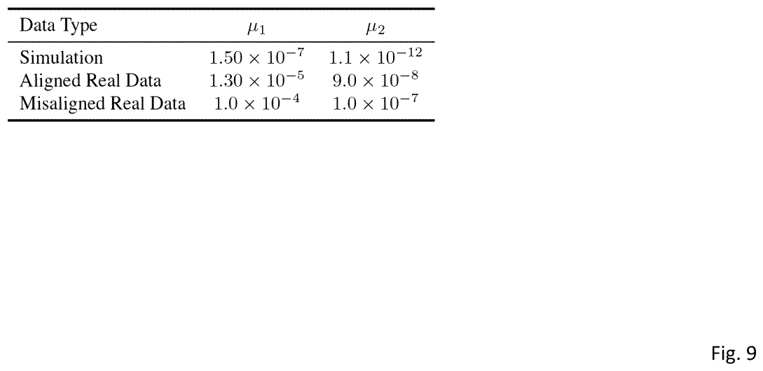

The retuning of parameters is done through a three-step manual grid search. In the first operation, a logarithmic search is performed over a wide range of values, testing μ₁ and μ₂ between 10-15 and 10-5, incrementing by a factor of 10 at each iteration. This operation provides a coarse estimation of the optimal range for each parameter. In the second operation, a linear grid search is performed within the range identified in the first operations. This narrows down the parameter values with greater precision. Optionally, a final linear grid search can be conducted around the most promising values from operation two to fine-tune the parameters. If the proposed method is to be tested on a new dataset, one can first tune the ADMM parameters on a representative sample image from the dataset. FIG. 9 is table that depicts ADMM parameters for simulation and real data in accordance with an illustrative embodiment. The ADMM parameters are kept constant across experiments on the same dataset. The ADMM parameters can be retuned to account for changes such as image size, or FFT window size.

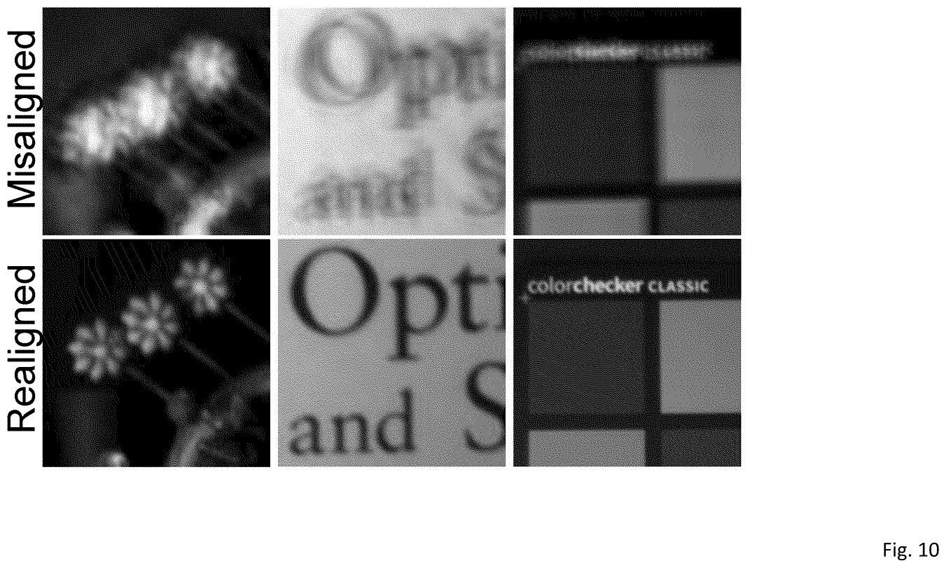

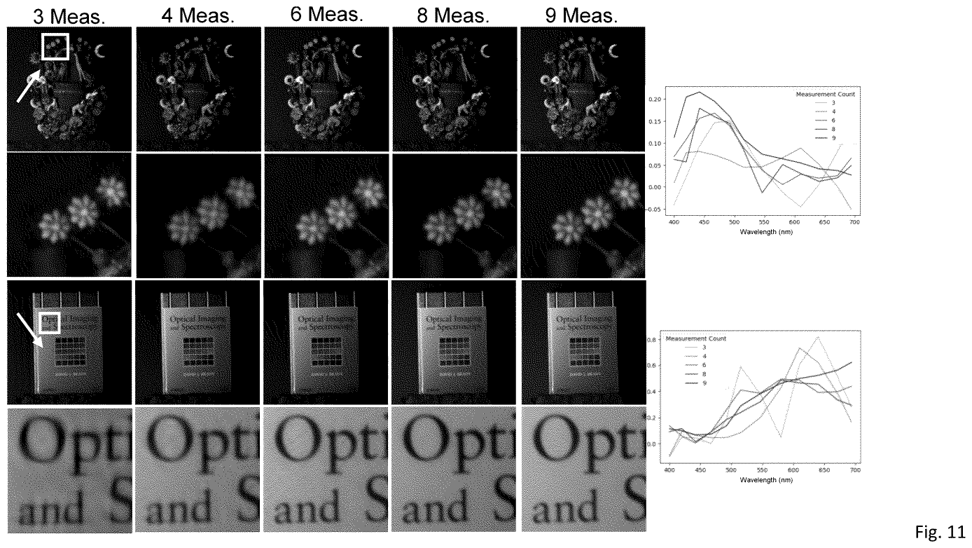

It is noted that the proof-of-concept prototype experienced camera misalignment between different measurements due to mechanical slack. To address this issue, the inventors used phase cross-correlation from scikit-image to realign the measurements. FIG. 10 depicts the results of the reconstruction from misaligned images, compared to the aligned reconstruction in accordance with an illustrative embodiment. As shown, the reconstructed images with misaligned measurements result in color fringing and distorted details. The reconstructed images with realigned measurements demonstrate sharper results. Applying ADMM to misaligned images requires higher regularization. To generate the top row of FIG. 10, the inventors ran a reconstruction with ADMM parameters μ₁ and μ₂ set to 10⁻⁴ and 10⁻⁷ (see FIG. 9) to account for increased numerical errors.

The number of measurements is a critical hardware-related hyperparameter, as it directly influences the trade-off between measurement acquisition time and reconstruction quality. To investigate this trade-off, hyperspectral images were reconstructed using varying numbers of measurements, and the resulting spatial and spectral reconstruction qualities were compared. FIG. 11 shows that spatial reconstruction quality improves with an increasing number of measurements but saturates beyond eight measurements, in accordance with an illustrative embodiment. In contrast, spectral reconstruction quality continues to improve as the number of measurements increases. It is also important to note that the reconstruction results are based on data collected using the proposed imaging system.

Derivation of the ADMM is discussed below. To derive the ADMM, the inventors first formulated an augmented Lagrangian [symbol] (v, z, u, ξ, η) as:

$$ℒ ( v , z , u , ξ , η ) = \frac{1}{2} {‖ y - Cv ‖}_{2}^{2} + {Φ}_{θ} ( u ) + \frac{1}{2} {u}_{1} {‖ v - \hat{H} z ‖}_{2}^{2} + {ξ}^{T} ( v - \hat{H} z ) + \frac{1}{2} {u}_{2} {‖ u - z ‖}_{2}^{2} + {η}^{T} ( u - z ) . \qquad Eq . 10$$

In the derivation of the ADMM, the algorithm alternates between solving subproblems for the primary variables and updating the dual variables based on optimality conditions. More specifically, the updating can be:

$${v}_{i + 1} = arg {min}_{v} ℒ ( {z}_{i} , {u}_{i} , v , {ξ}_{i} , {η}_{i} ) \qquad Eq . 11$$

$${z}_{i + 1} = arg {min}_{z} ℒ ( z , {u}_{i} , {v}_{i + 1} , {ξ}_{i} , {η}_{i} ) \qquad Eq . 12$$

$${u}_{i + 1} = {P}^{T} {∅}_{θ} P ( {z}_{i + 1} + {η}_{i} ) \qquad Eq . 13$$

$$\text{?} \qquad Eq . 14$$

$${ξ}_{i + 1} ← {ξ}_{i} + {μ}_{1} ( {v}_{i + 1} - \hat{H} {z}_{i + 1} ) \qquad Eq . 15$$

$${η}_{i + 1} ← {η}_{i} + {μ}_{2} ( {u}_{i + 1} - {z}_{i + 1} ) \qquad Eq . 16$$

$$\text{?} \text{indicates text missing or illegible when filed}$$

In the v update, one can solve the subproblem of Eq. (11) by using the following analytical solution:

$${v}_{i + 1} = {( {C}^{T} C + {μ}_{1} I )}^{- 1} ( {C}^{T} y + {μ}_{1} \hat{H} {z}_{i} - {ξ}_{i} ) . \qquad Eq . 17$$

In the z update, one can use the following analytical solution to the subproblem of Eq. (12), as follows:

$${z}_{i + 1} = {( {μ}_{1} {\hat{H}}^{T} \hat{H} + {μ}_{2} I )}^{- 1} ( {\hat{H}}^{T} ( {μ}_{1} {v}_{i + 1} + {ξ}_{i} ) + ( {η}_{i} + {μ}_{2} {u}_{i} ) ) . \qquad Eq . 18$$

The matrix inversion in Eq. (17) is straightforward to implement because the matrix is diagonal. However, the matrix inversion in Eq. (18) necessitates a specialized implementation; otherwise, the computational burden becomes prohibitively high for such a large matrix. Since each submatrix of H represents a 2D linear convolution matrix, one can implement it using a 2D circulant convolution by padding the input, such that:

$$HPz = {H}_{circ} {P}_{pad} {z}_{pad} , \qquad Eq . 19$$

where each block of H_{circ} is a square matrix that performs the 2D circulant convolution. Since most of the following operations and matrices are applied to the padded version of z, one can define \tilde{H}:=H+K−1 and \tilde{W}:=W+K−1 to simplify the notation. Here P_{pad}:=B^{T}⊗I_{Ĥ\tilde{W}} and _{xpad} denotes the padded version of x. With this implementation, the following property results:

$${H}_{circ} = ( {I}_{N} ⊗ {F}^{H} ) [ \begin{matrix}{\sum }_{1 , 1} & … & {\sum }_{1 , C} \\ ⋮ & ⋱ & ⋮ \\ {\sum }_{N , 1} & … & {\sum }_{N , C}\end{matrix} ] ( {I}_{C} ⊗ F ) , \qquad Eq . 20$$

where F^{H} denotes the conjugate transpose of the 2D discrete Fourier transform (DFT) matrix F with the size of \tilde{H}\tilde{W} and Σ_{i,j}∈ [symbol] ^{\tilde{H}\tilde{W}×\tilde{H}\tilde{W}} denotes a diagonal matrix. Specifically, the matrix F can be expressed as:

$$F = {F}_{1 , D \tilde{W}} ⊗ {F}_{1 D , \tilde{H}} , \qquad Eq . 21$$

where F_{1D,n} represents a one-dimensional discrete Fourier transform (DFT) matrix of size n. Furthermore, it is assumed that the images in each channel are column-stacked.

By using the property in Eq. (20), one can determine that:

$${P}_{pad}^{T} {H}_{circ}^{T} {H}_{circ} {P}_{pad} = {P}_{pad}^{T} ( {I}_{C} ⊗ {F}^{H} ) \hat{\sum } ( {I}_{C} ⊗ F ) {P}_{pad} , \qquad Eq . 22$$

where \hat{Σ}∈ [symbol] ^{\tilde{H}\tilde{W}C×\tilde{H}\tilde{W}C} is defined as:

$$\hat{\sum } := {[ \begin{matrix}{\sum }_{1 , 1} & … & {\sum }_{1 , C} \\ ⋮ & ⋱ & ⋮ \\ {\sum }_{N , 1} & … & {\sum }_{N , C}\end{matrix} ]}^{H} [ \begin{matrix}{\sum }_{1 , 1} & … & {\sum }_{1 , C} \\ ⋮ & ⋱ & ⋮ \\ {\sum }_{N , 1} & … & {\sum }_{N , C}\end{matrix} ] \qquad Eq . 23$$

It is evident that each block of the matrix \hat{Σ} remains diagonal. To further leverage the special structure of \hat{Σ}, one can utilize a permutation matrix P_{π}∈ [symbol] ^{\tilde{H}\tilde{W}C×\tilde{H}\tilde{W}C} to transform it into a block diagonal matrix as:

$$D = {P}_{π}^{T} \hat{\sum } {P}_{π} , \qquad Eq . 24$$

where D denotes a block-diagonal matrix, and the elements of the matrix P_{π} corresponding to the i^{th} row and the j^{th} column are defined as follows:

$${( {P}_{π} )}_{ij} = \{ \begin{matrix}1 , & if j = C {mod ( i - 1 )}_{{N}_{p}} + ⌊ \frac{i - 1}{{N}_{p}} ⌋ + 1 \\ 0 , & otherwise\end{matrix} . \qquad Eq . 25$$

Here the scalar Nₚ is equal to \tilde{H}\tilde{W}. By combining Equations 24 and 22, one can arrive at:

$${P}_{pad}^{T} {H}_{circ}^{T} {H}_{circ} {P}_{pad} = {P}_{pad}^{T} ( I ⊗ {F}^{H} ) {P}_{π} {DP}_{π}^{T} ( I ⊗ F ) {P}_{pad} = ( I ⊗ {F}^{H} ) {P}_{pad}^{T} {P}_{π} {DP}_{π}^{T} {P}_{pad} ( I ⊗ F ) . \qquad Eq . 26$$

The last equality in Eq. 26 holds due to the property (B⊗I) (I⊗F^{H})=B⊗F^{H}=(I⊗F^{H})(B⊗I). Using Eq. 26, the matrix inversion in Eq. 18 can be expressed as:

$${( {μ}_{1} {\hat{H}}^{T} \hat{H} + {μ}_{2} I )}^{- 1} = ( I ⊗ {F}^{H} ) {P}_{pad}^{T} {{P}_{π} ( {μ}_{1} D + {μ}_{2} I )}^{- 1} {P}_{π}^{T} {P}_{pad} ( I ⊗ F ) . \qquad Eq . 27$$

This reformulation in Eq. (27) allows one to compute the inverse by inverting only the blocks of the block-diagonal matrix D. It is worth noting that, in the proposed implementation, the permutation matrix is not explicitly constructed. Instead, one can apply the discrete Fourier transform and matrix inversion along different axes. By leveraging this approach—applying operations along specific axes and reshaping the data into a four-dimensional (4D) cube—the proposed implementation achieves real-time reconstruction.

A noise sensitivity analysis was also conducted. Inspired by the definition of the condition number, one can use the ratio of the largest singular value and the least nonzero singular value of the forward operator for investigating noise sensitivity. It is noted that the cropping matrix C is excluded since it is not designed for preserving the information. More specifically, the ratio is defined as:

$$\hat{κ} ( A ) = \frac{{σ}_{max} ( A )}{{\hat{σ}}_{min} ( A )} , \qquad Eq . 28$$

where A denotes an input matrix. The scalars σₘₐₓ(A) and \hat{σ}ₘᵢₙ(A) denote the largest singular value and the least non-zero singular value of the matrix A. By using the block diagonal forward operator defined in Eq. (24), one can compute the ratio for each block, which corresponds to a Fourier component. This allows for identification of which frequencies are more noise-resistant and which ones require additional regularization. However, in the current implementation, the inventors applied uniform regularization (i.e., μ₁ and μ₂) across all Fourier components and do not take advantage of this frequency-specific analysis.

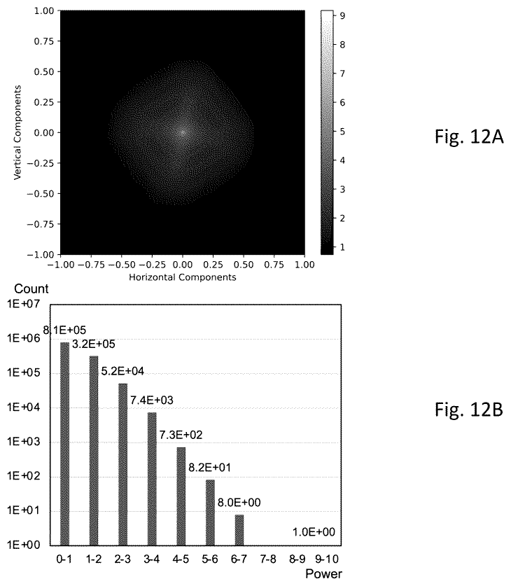

FIG. 12 shows the ratio for each spatial Fourier component, and the overall distribution of displayed values. Specifically, FIG. 12 show the image and histogram of the ratio \hat{κ}(D) in a log-log scale. FIG. 12A shows the vertical components and horizontal components in accordance with an illustrative embodiment. The x and y axes represent the normalized spatial frequency. It can be observed that most of the noise-sensitive Fourier components are concentrated in the low spatial frequency regions. FIG. 12B is a histogram depicting the overall distribution of values in accordance with an illustrative embodiment. In FIG. 12B, the x axis represents the power of the ratio in base of 10 and the y axis denotes the count.

The histogram plot of FIG. 12B shows that 99.3% of the Fourier components have the ratio smaller than 103, meaning these components can be relatively easier to be reconstructed due to better noise resistance. However, most of the relatively noise-sensitive Fourier components are concentrated in the low spatial frequency regions, which carry most of the image energy. This can jeopardize the reconstructed image quality since most of the image energy is accompanied with the sensitive Fourier components.

To further analyze the information preservability of the forward operator, the inventors used mutual coherence as a comparative metric against CASSI-type systems. Mutual coherence is defined as:

$$μ ( A ) = {max}_{i \neq j} \frac{\vert {A}_{i}^{H} {A}_{j} \vert}{{‖ {A}_{i} ‖}_{2} {‖ {A}_{j} ‖}_{2}} , \qquad Eq . 29$$

where Aᵢ and Aⱼ are columns of the forward operator matrix A. This metric quantifies the similarity between the columns, with a mutual coherence value closer to 0 indicating better information preservability, particularly for methods that exploit sparsity. In the simulations, where the CfD algorithm was allowed to take four measurements, the forward operator achieves a mutual coherence of 0.71, compared to the Snapshot CASSI system, which exhibits a mutual coherence of 1.0.

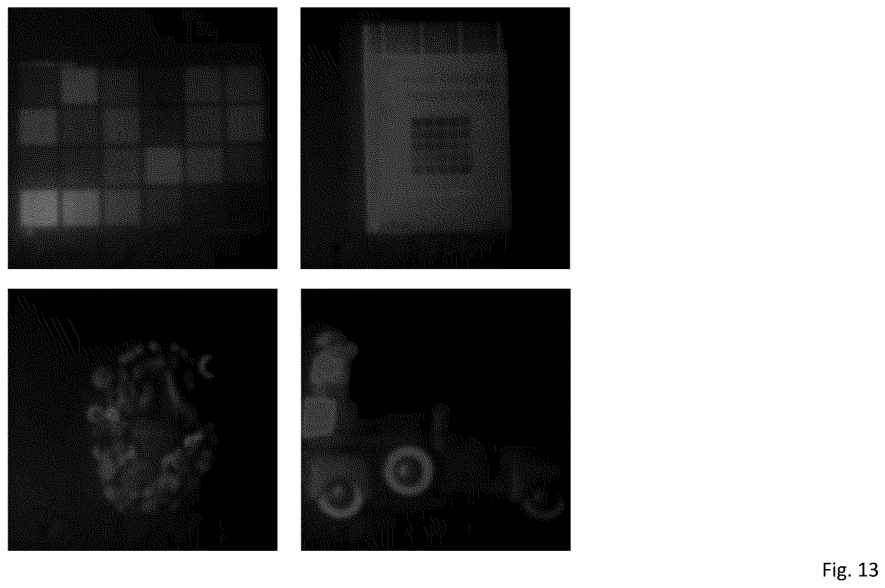

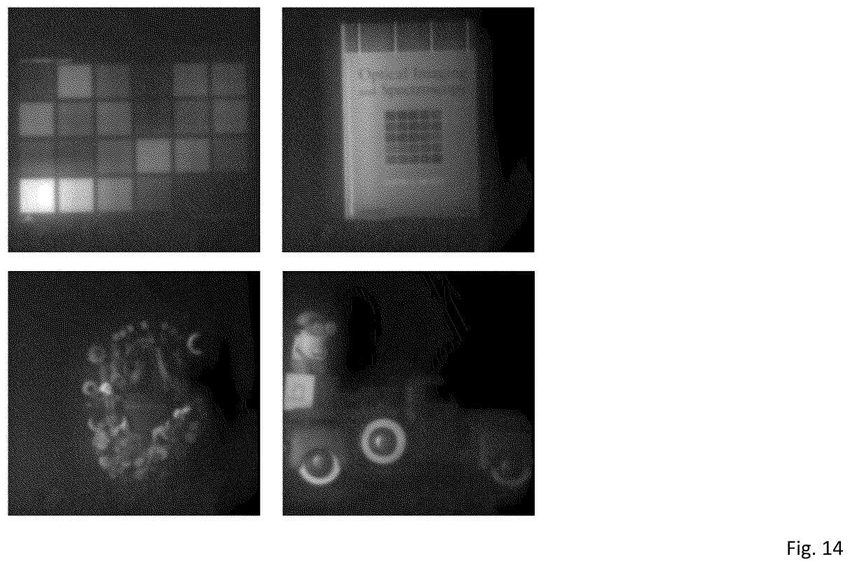

To better understand the functionality of the proposed camera and verify whether the measurements contain color information, the inventors conducted a visualization experiment. Three grayscale measurements were stacked, corresponding to in-focus wavelengths of 671 nm, 546 nm, and 442 nm, along the channel dimension. Finally, the images were white balanced using the white patch in the color checker. As shown in FIGS. 13 and 14, the optical system recovers some color just by dispersing the power of out of focus wavelengths without any computation.

FIG. 13 depicts RGB scene images composed using measurements without white balance in accordance with an illustrative embodiment. The four scene images are composed by stacking three measurements, corresponding to in-focus wavelengths of 671 nm, 546 nm, and 442 nm. FIG. 14 shows RGB scene images composed using measurements with white balance in accordance with an illustrative embodiment. In FIG. 14, the four scene images are generated by combining three measurements, each corresponding to specific in-focus wavelengths: 671 nm, 546 nm, and 442 nm. White balance adjustments were applied to ensure accurate color representation. The reference white color is taken from the white square of the color-chart scene image.

The choice of prior information plays a critical role in determining the quality of reconstruction. In the conducted experiments, a deep denoiser consistently outperforms the traditional l1-norm regularization in handling noise and reconstruction artifacts. The deep denoiser's ability to model complex data distributions allows it to effectively suppress noise while preserving fine details in the reconstructed images, without requiring extensive parameter tuning. This makes it particularly well-suited for scenarios with varying noise levels. In contrast, l1-norm regularization exhibits a tradeoff that depends heavily on the noise level and hyperparameter selection. When applied conservatively, l1-norm regularization performs well in low-noise scenarios, recovering fine details. However, it tends to amplify noise when applied to low-SNR measurements, leading to degraded reconstructions.

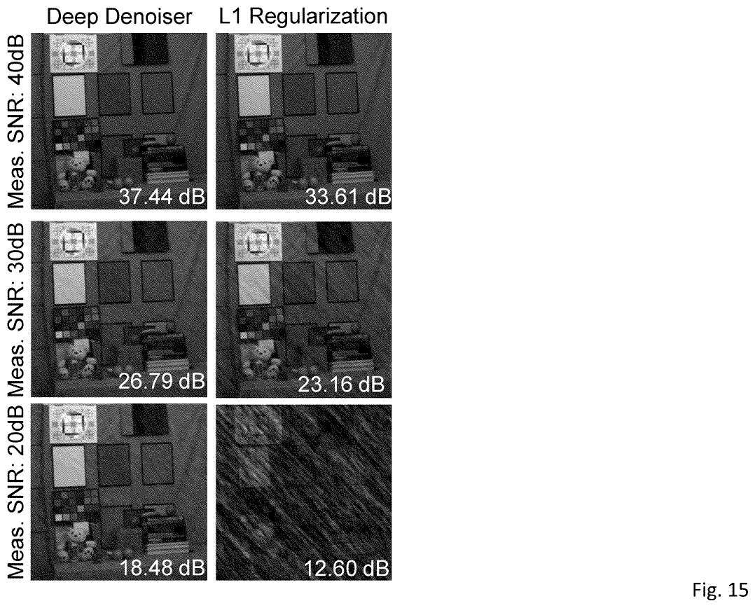

FIG. 15 considers the effect of prior information on reconstruction results and compares use of a deep denoiser to use of l1-norm regularization in accordance with an illustrative embodiment. As shown, the deep denoiser handles noise and reconstruction artifacts better than l1-norm regularization. In FIG. 15, measurement SNR is given with respect to blurred measurements and reconstruction SNR is given with respect to sharp ground truth images.

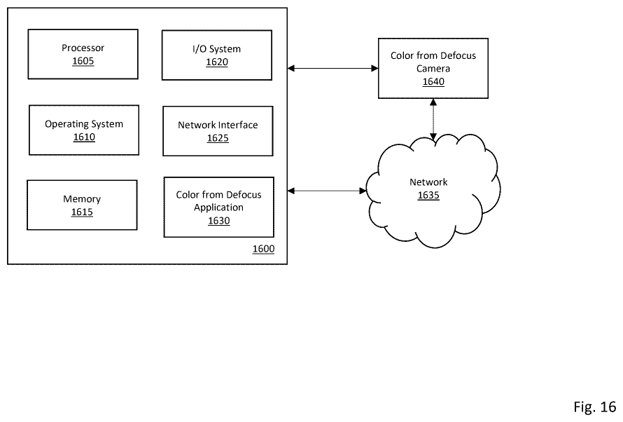

In an illustrative embodiment, any of the operations described herein can be implemented by a system that includes a computing device. For example, the operations can be stored as computer-readable instructions that, upon execution by a processor, perform the operations described herein. FIG. 16 depicts a computing device 1600 that generates images for a color from defocus imaging system in accordance with an illustrative embodiment. As shown, the computing device 1600 is in direct or indirect (i.e., through a network 1635) communication with a color from defocus camera 1640. Accordingly, the computing device 1600 is able to receive image data captured by the color from defocus camera 1640 and use that image data to generate images as described herein. The computing device 1600 can be a cell phone, tablet, laptop computer, etc. In an alternative embodiment, the computing device 1600 can be a dedicated computing device that is incorporated into the color from defocus camera 1640.

The computing device 1600 includes a processor 1605, an operating system 1610, a memory 1615, an input/output (I/O) system 1620, a network interface 1625, and a color from defocus application 1630. In alternative embodiments, the computing device 1600 may include fewer, additional, and/or different components. The components of the computing device 1600 can communicate with one another via one or more buses or any other interconnect system.

The processor 1605 of the computing device 1600 can be in electrical communication with and used to control any of the system components described herein, including the color from defocus camera 1640. The processor 1605 can be any type of computer processor known in the art, and can include a plurality of processors and/or a plurality of processing cores. The processor 1605 can include a controller, a microcontroller, an audio processor, a graphics processing unit, a hardware accelerator, a digital signal processor, etc. Additionally, the processor 1605 may be implemented as a complex instruction set computer processor, a reduced instruction set computer processor, an x86 instruction set computer processor, etc. The processor 1605 is used to run the operating system 1610, which can be a standard operating system or a custom operating system specific to the requirements of the proposed system.

The operating system 1610 is stored in the memory 1615, which is also used to store programs, prior information, algorithms, network and communications data, peripheral component data, the color from defocus application 1630, and other operating instructions. The memory 1615 can be one or more memory systems that include various types of computer memory such as flash memory, random access memory (RAM), dynamic (RAM), static (RAM), a universal serial bus (USB) drive, an optical disk drive, a tape drive, an internal storage device, a non-volatile storage device, a hard disk drive (HDD), a volatile storage device, etc.

The I/O system 1620, or user interface, is the framework which enables users (and peripheral devices) to interact with the computing device 1600. The I/O system 1620 can include one or more keys or a keyboard, one or more buttons, one or more displays, a speaker, a microphone, etc. that allow the user to interact with and control the computing device 1600. The I/O system 1620 also includes circuitry and a bus structure to interface with peripheral computing components such as power sources, sensors, etc. The I/O system 1620 can also include a printer to print generated images.

The network interface 1625 includes transceiver circuitry that allows the computing device 1600 to transmit and receive data to/from other devices such as user device(s), remote computing systems, servers, websites, the color from defocus camera 1640, etc. The network interface 1625 enables communication through the network 1635, which can be one or more communication networks. The network 1635 can include a cable network, a fiber network, a cellular network, a wi-fi network, a landline telephone network, a microwave network, a satellite network, etc. The network interface 1625 also includes circuitry to allow device-to-device communication such as near field communication (NFC), Bluetooth® communication, etc.

The color from defocus application 1630 can include hardware, software, and algorithms (e.g., in the form of computer-readable instructions) which, upon activation or execution by the processor 1605, performs any of the various operations described herein such as controlling the color from defocus camera 1640, receiving image data from the color from defocus camera 1640, processing received image data, generating images, displaying and/or printing generated images, etc. The color from defocus application 1630 can utilize the processor 1605 and/or the memory 1615 as discussed above.

Thus, inspired by the efficiency and robustness of natural vision, the inventors have demonstrated a method for Color from Defocus that recovers RGB and hyperspectral images from grayscale focal stacks. The method uses simple, widely-available optics and less than a second of GPU compute per frame. Its hyperspectral reconstructions are comparable to much more optically and computationally intensive systems and have been validated in simulation and on data from a hardware prototype, indicating a way forward to high-quality spectral imaging in resource-constrained settings. The inventors aim to improve this work by exploring design tradeoffs in terms of metrics reported here as well as novel criteria. These include improved hyperspectral metrics such as earth-mover's distance (EMD). A key parameter in this design space is the measurement count (particularly for scenes with motion or limited photon budgets) and its observed trade-off with the required internal dimension of color representation.

In summary, the main contributions of the proposed system are as follows: i) the simple hardware prototype uses off-the-shelf, low-cost optical components commonly found in consumer hardware such as smartphone cameras, ii) the algorithm runs in real time, taking <1 second(s) to reconstruct a 1000×1000 pixel, 12 channel hyperspectral image, and iii) the reconstructed spectra are state-of-the-art comparable in simulation and produce near-imperceptible red green blue (RGB) errors in real hardware.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more.”

The foregoing description of illustrative embodiments of the invention has been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1. A system for obtaining color images, the system comprising:
a grayscale imaging device;
a first lens positioned at a first distance from the grayscale imaging device;
a second lens positioned at a second distance from the grayscale imaging device, wherein the second distance is greater than the first distance; and
a processor operatively coupled to the grayscale imaging device, wherein the processor is configured to:
receive image data from the grayscale imaging device;
use a compressed sensing framework to process the image data; and
generate a hyperspectral image based on the processed image data.

2. The system of claim 1, wherein the first lens is fixed in place.

3. The system of claim 2, wherein the second lens moves relative to the first lens.

4. The system of claim 3, wherein the second lens moves between N positions corresponding to N different effective focal lengths.

5. The system of claim 3, wherein a captured image at a given position is focused on a specific wavelength such that other wavelengths are blurred at the given position.

6. The system of claim 1, wherein the image data comprises unfocused grayscale image data.

7. The system of claim 1, further comprising an aperture on the second lens.

8. The system of claim 7, wherein the second lens has a proximate surface and a distal surface, wherein the distal surface is further from the grayscale imaging device than the proximate surface, and wherein the aperture is mounted to the distal surface of the second lens.

9. The system of claim 1, wherein the image data comprises a focal stack of grayscale images.

10. The system of claim 1, wherein the processor processes the image data by solving an inverse problem that includes a linear two-dimensional convolutional matrix generated by a point spread function.

11. The system of claim 10, wherein the processor formulates a minimization problem in eigenspace to solve the inverse problem.

12. The system of claim 1, further comprising a denoiser to suppress noise in the image data.

13. A method of obtaining color images, the method comprising:
capturing image data by a grayscale imaging device of an optical system, wherein the optical system includes a first lens positioned at a first distance from the grayscale imaging device and a second lens positioned at a second distance from the grayscale imaging device, wherein the second distance is greater than the first distance;
processing, by a processor operatively coupled to the grayscale imaging device, the image data using a compressed sensing framework; and
generating, by the processor, a hyperspectral image based on the processed image data.

14. The method of claim 13, wherein the first lens is fixed in place and wherein the second lens moves relative to the first lens.

15. The method of claim 14, wherein capturing the image data includes moving the second lens between N positions corresponding to N different effective focal lengths.

16. The method of claim 13, wherein the image data comprises unfocused grayscale image data.

17. The method of claim 13, further comprising placing an aperture on the second lens.

18. The method of claim 17, wherein the aperture is placed on a distal surface of the second lens.

19. The method of claim 13, further comprising processing the image data by solving an inverse problem that includes a linear two-dimensional convolutional matrix generated by a point spread function.

20. The method of claim 19, further comprising formulating a minimization problem in eigenspace to solve the inverse problem.
